(19) United States
(12) Patent Application Publication
(10) Pub. No.: US 2024/0114839 A1
(43) Pub. Date: Apr. 11, 2024

(54) BALE HANDLING DEVICES

(71) Applicant: BERTHA MANUFACTURING, LLC, Hicksville, OH (US)

(72) Inventor: Jeffrey J PETER, Hicksville, OH (US)

(21) Appl. No.: 18/144,736

(22) Filed: May 8, 2023

Related U.S. Application Data
(63) Continuation-in-part of application No. PCT/US22/51612, filed on Dec. 2, 2022.
(60) Provisional application No. 63/286,013, filed on Dec. 4, 2021.

(51) Int. Cl. A01D 90/08

(52) U.S. Cl. CPC A01D 90/08

(57) ABSTRACT

The present invention involves a mechanism for collecting bales left in fields. The mechanism includes a bale collecting attachment configured for being operationally mounted on a vehicle, such as a skid skeeter, a tractor, wheel loader, all-terrain vehicle, or other off-road vehicle. The attachment includes a vehicle attachment portion. a frame support portion operably coupled to the vehicle attachment portion, and a bale securing portion pivotally mounted on the frame support. The bale securing portion has a spear, fork, clamp or similar mechanism to grab a bale in the field. In some embodiments, the bale securing portion is capable of pivotally moving the bale so that a bale may be picked up by the attachment, the vehicle may then move the attachment to a larger transport facility where the bale may be set down and unloaded.

### CROSS-REFERENCE TO RELATED APPLICATIONS

The present application is a continuation-in-part of International Patent Application Serial No. PCT/US22/51612, filed Dec. 2, 2022, under the Patent Cooperation Treaty claiming priority under 35 U.S.C. § 119(e) from, U.S. Provisional Patent Application Ser. No. 63/286,013, filed on Dec. 4, 2021.

### BACKGROUND

Rolled or round bales are a common way to collect and store forage crops and straw. The cylinder shaped round bales are formed by rolling grass or other material on rotating belts inside a baler to form bales typically from 48 to 72 inches in diameter (or about 120 to 160 centimeters) and 48-72 inches in length which are secured with twine or netting wrap, and occasionally by plastic wrap. Round bales have a variety of advantages over traditional square bales by collecting a large mass of material in a smaller volume which allows for the use of less wrapping material as well as fewer trips to haul bales from field to storage and from storage to feeding.

One disadvantage of round bales is that they are dropped directly on the field by the baler as they are produced which requires they later be collected and moved either to the side of the field or loaded directly onto trucks or wagons. As round bales typically may weight 2000 pounds or more they require mechanized means of collecting and moving. Typically, this collection is accomplished using a tractor 20 having loader 22 equipped with a bale fork or spear 24 as shown in FIG. 1. Spear 24 is positioned so that it may be driven into the center of the diameter of a round bale 30 and then lifted using loader 22. In some instances, a second spear 28 may be mounted to the tractor's three-point hitch 26 allowing a second round bale 30 to be carried at the same time. Such an arrangement is slow as it only allows for the transport of up to two bales at a time. The speed at which the tractor may operate may be limited in rough or uneven fields as the weight distribution of having heavy loads at the front and back of the tractor may cause excessive bouncing or rocking if operated too quickly. Second spear 28 mounted to three-point hitch 28 may allow for two bales to be moved simultaneously, but three-point hitches are incapable of lifting a bale high enough to be loaded onto a truck or wagon. Any bale transported across a field on three-point hitch 26 must be dropped on the ground and picked up with spear 24 mounted to front loader 22 to be loaded onto a truck or wagon. What is needed are bale handling devices capable of moving and loading round bales more quickly and efficiently.

### SUMMARY

In one aspect a bale handling device is disclosed as having a vehicle attachment portion, a frame support operationally connected to the vehicle attachment portion and having a first main frame member with a first side frame member at one end and a second side frame member distal from the first side frame member, and at least one bale securing assembly pivotably mounted to the frame support and having a bale engaging member and being movable between a first position and a second position. Optionally, the bale handling device further includes a hydraulic controller mounted to the bale handling device and operably connectable to a hydraulic system of a vehicle engaged with the vehicle attachment portion, the hydraulic controller configured to move the at least one bale securing assembly between the first position and the second position. Further, the first position may be a lowered position, the second position may be a carry position, and the at least one bale securing assembly may further movable to a third position that is a raised position. In other embodiments, a second and third bale securing assembly are pivotally mounted on the frame support between the first side frame member and the second side frame member and are movable between a first position and a second position, wherein each bale securing assembly is individually movable by the hydraulic controller between the first position and the second position. The first and second side frame members may also include at least one wheel operationally mounted thereto. The vehicle attachment portion may be disposed between the first and second side frame members. Optionally, a second main frame member disposed between the first side frame member and the second side frame member, wherein the at least one bale securing assembly is pivotally mounted to the second main frame member. Optionally, moisture sensors may be mounted to one or more bale securing assembly. Each bale securing assembly may include one of a bale spear, pallet forks, bale clamps, and tubular lift fingers.

In another aspect methods of using the disclosed bale handling devices are described which include attaching a vehicle having a hydraulic system to a vehicle attachment portion of the bale handling device, operationally connecting a hydraulic controller of the bale handling device to the vehicle hydraulic system, positioning the vehicle so as to engage a first fodder bale with one of the at least two bale securing assembly in the first position, operating the vehicle hydraulic system to selectively move the bale securing assembly engaged with the first fodder bale to the second position thereby lifting the first fodder bale, positioning the vehicle so as to engage a second fodder bale with the other of the at least two bale securing assembly in the first position, operating the vehicle hydraulic system to selectively move the bale securing assembly engaged with the second fodder bale to the second position thereby lifting the second fodder bale, driving the vehicle and bale handling device to a desired location, operating the vehicle hydraulic system to selectively move the bale securing assembly engaged with the first fodder bale to the first position, operating the vehicle hydraulic system to selectively move the bale securing assembly engaged with the second fodder bale to the first position, and positioning the vehicle so as to disengage the first and second fodder bales from the at least two bale securing assemblies.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a side view of a Prior Art tractor using prior-art bale handling devices.

FIG. 2 is a perspective view of a bale handling device according to one embodiment of the present invention.

FIG. 3 is a rear view of a portion of the bale handling device shown in FIG. 2.

FIG. 4 is a front view of the bale handling device shown in FIG. 2.

FIG. 5 is a top plan view of a bale handling device according to another embodiment.

FIG. 6 is a side view of the bale handling device shown in FIG. 5.

FIG. 7 is a top plan view of a bale handling device according to still another embodiment.

FIG. 8 is a partial cross sectional side view of a lift assembly of a bale handling device in the lowered position.

FIG. 9 is a partial cross sectional side view of the lift assembly of FIG. 8 in the raised position.

FIG. 10 is perspective view of a bale handling device according to another embedment.

FIG. 11 is a close-up perspective view of the bale handling device shown in FIG. 10.

FIG. 12 is a top plan view of a bale handling device according to one embodiment.

FIG. 13 is a partial cross sectional side view of the bale handling device shown in FIG. 12.

FIG. 14 shows a side view of a bale handling device attachment according to one embodiment.

FIG. 15 shows a side view of a bale handling assembly according to another embodiment.

FIG. 16 is a side view of the bale handling device assembly of FIG. 15 in the raised position.

FIG. 17 shows a perspective view of an optional pallet lift attachment for a bale handling device.

FIG. 18 shows a perspective view of an optional spear attachment for a bale handling device.

FIG. 19 shows a perspective view of an optional clamp attachment for a bale handling device.

FIG. 20 shows a perspective view of an optional finger attachment for a bale handling device.

FIG. 21 shows a perspective view of an optional multi-spear attachment for a bale handling device

FIG. 22 shows a perspective view of an optional modifiable frame attachment for a bale handling device.

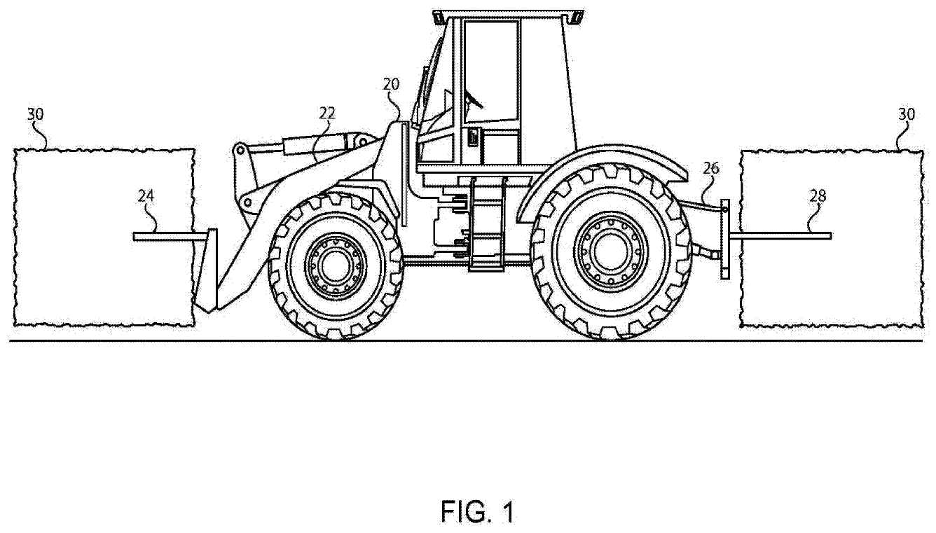

Corresponding reference characters indicate corresponding parts throughout the several views. Although the drawings represent embodiments of the present invention, the drawings are not necessarily to scale and certain features may be exaggerated in order to better illustrate and explain the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

For illustrative purposes only examples will be shown of bale handling devices according to the disclosed technology used with skid steer style loaders. It is understood that the bale handling devices shown herein may be adjusted or configured to work with other suitable styles of loading equipment which have one or more lift arms or mechanisms as well as one or more hydraulic pumps and the capability to connect their hydraulic systems to auxiliary devices. Examples of such loading equipment include, but are not limited to, skid steer loaders, wheel loaders, tractors, telehandlers, and the like.

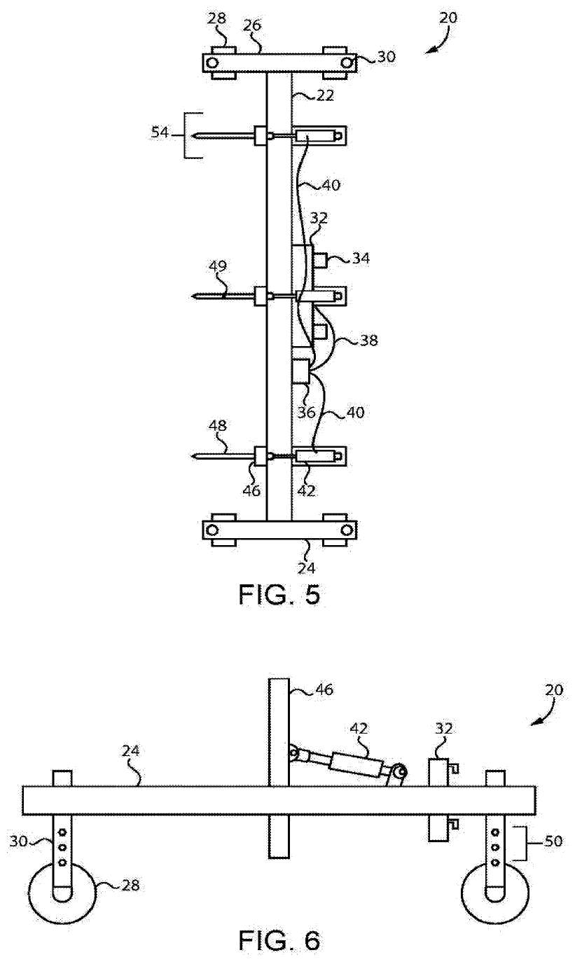

Shown in FIGS. 5-6 is one example of a bale handling device according to the disclosed technology. In this example, bale handling device 20 includes a first/main frame member 22 connecting two side frame members 24, 26. The frame members may be made from any suitably strong and ridged material such as box or tubular steel. Each side frame member includes at least one adjustable wheel bracket 30 and wheel 28. In this particular example, each side frame member includes two wheels and wheel adjustable wheel brackets, but in other examples each side member might more or fewer wheel brackets and wheels. Optionally, the adjustable wheel brackets include hardware such as a pivot or pintle which allows the wheels to operate as castors thereby allowing the bale handling device to be pushed or pulled in any direction. In such configurations the adjustable wheel brackets may also include a locking mechanism so as to prevent the castor wheels from pivoting. Adjustable wheel brackets 30 further include height adjustment mechanism 50 for adjusting and locking the distance between wheels 28 and side frames 24, 26. Height adjustment mechanism 50 may be mechanical in nature (e.g., a series of holes and locking pins) or it may be hydraulically controlled (e.g., using hydraulic rams), or other suitable arrangement.

Bale handling device 20 shown in FIGS. 5-6 includes an attachment plate 32 having one or more attachment mechanisms 34 for attaching a loader machine to handling device 20. The exact number, configuration, and style of attachment mechanisms may vary according to the loading machine used. In other examples, an intermediary attachment device or adaptor may be used such that one side of the adaptor is configured for attachment to the bale handling device and the other side of the adaptor is configured for attachment to a particular loader or style of loader.

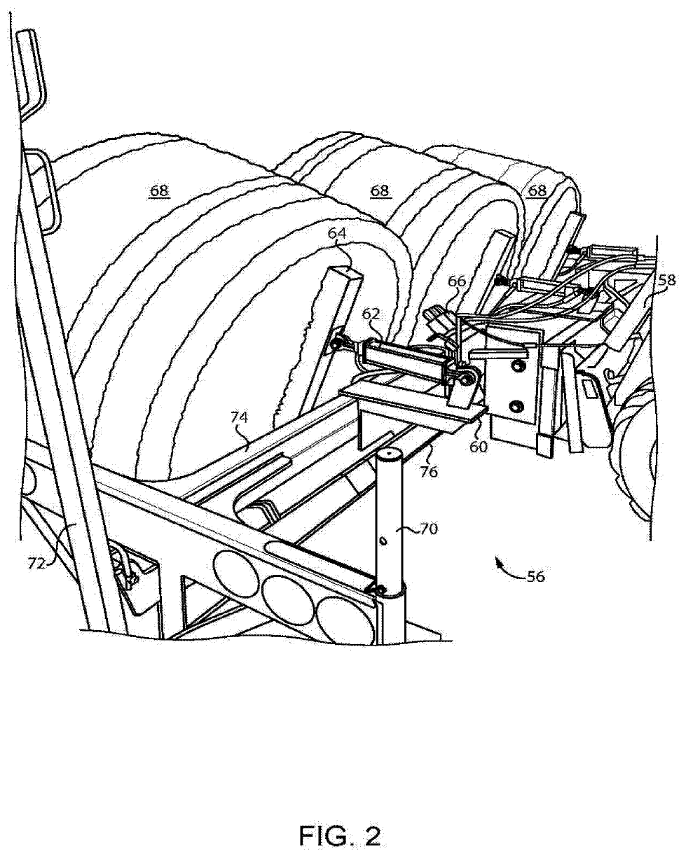

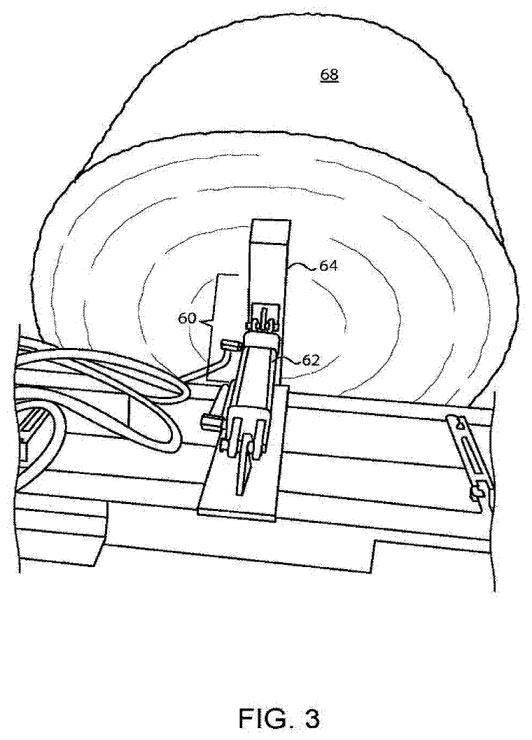

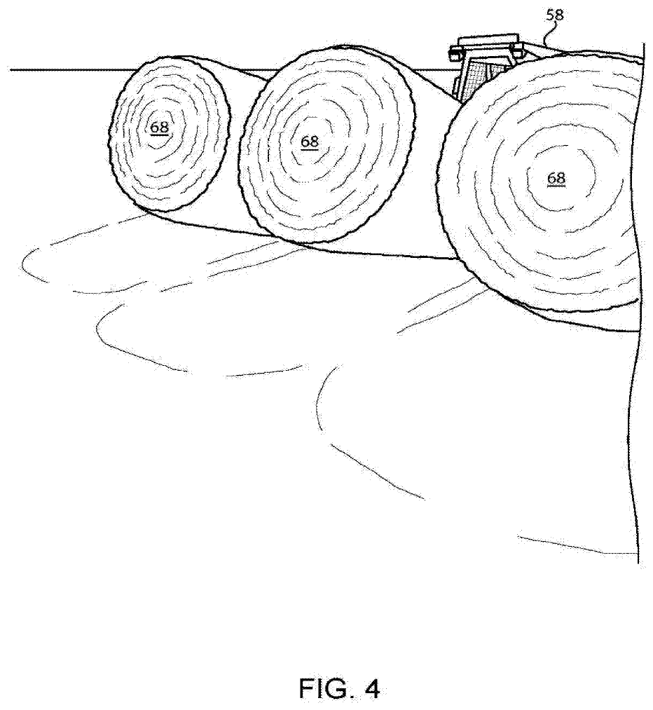

Bale handling device 20 further includes hydraulic controller 36 which includes attachment points for one or more hydraulic hoses. Typically, at least one hydraulic hose 38 is provided which is operably attached to the hydraulic system of the loading machine being used with the bale handling device. The exact number, size, and coupling mechanism used will vary according to the loading machine being used. Hydraulic controller 36 further includes at least one hydraulic hose operably connected to hydraulic ram 42 which is part of lift mechanism assembly 54 which is discussed in greater detail below. Hydraulic controller 36 acts as a manifold for distributing hydraulic fluid from the loader machine to hydraulic rams 42 of lift mechanism assemblies 54. In addition to the conventional electronics of hydraulic controller 36, optionally controller 36 may have interfaces with various sensors mounted on bale handling device 20. Such sensors 49 may be incorporated into lift mechanism 54, frame members 22, 26, 28, or other locations on bale handling device 20 and include, but are not limited to, weight sensors for measuring the weight of bales 68 (see FIGS. 2-4), moisture sensors for determining the moisture content of bales 68, position sensors for determining the size and location of bales 68, and/or temperature sensors or other monitoring devices. Controller 36 may include memory for storing sensed values, and/or telecommunications equipment for transmitting such information for further processing and/or storage. Optionally, such sensors may be hard wired into controller 36 or another suitable controller or they may interface with such controllers wirelessly using a suitable wireless communication system or protocol such as Wi-Fi and the like.

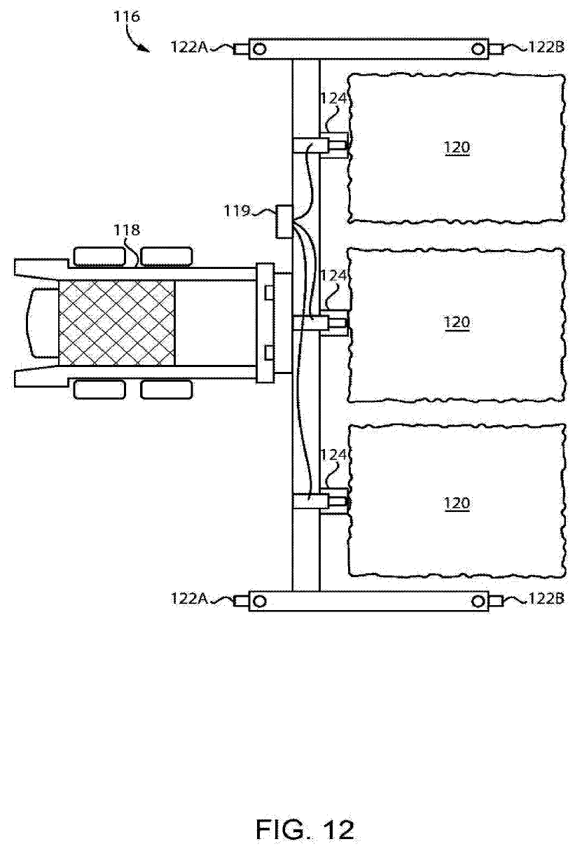

In this particular example, hydraulic controller 36 is shown as mounted to first frame member 22, but hydraulic controller may be mounted at other locations if desired, for example without limitation (see FIGS. 2 and 12, items 66 and 119, respectively). Conventional hydraulic control mechanisms may include directional levers, joystick controllers, and/or programmable motion sequences designed for manual activation or automatic sensor based operations control.

Bale handling device 20 also includes two or more lift mechanism 54 mounted to first frame member 22. In the example shown in FIGS. 5-6, bale handling device 20 includes three lift mechanisms 54. Lift mechanisms 54 include pivotable bracket 46 having bale spear or fork 48 as well as hydraulic ram 42. Hydraulic ram 42 is mounted and configured such that it can move pivotable bracket 46 between a first position and a second position which is discussed in greater detail below. Lift mechanisms 54 are spaced at a distance from one another such that each may fully engage with and lift one round bale 68 (see FIGS. 2-4). Optionally, the exact position of lift mechanisms 54 on bale handling device 20 relative to one another may be adjustable such that they may be moved closer together or farther apart so as to accommodate bales 68 of different sizes. In still other examples bale handling devices having more or fewer than three lift mechanisms are also contemplated.

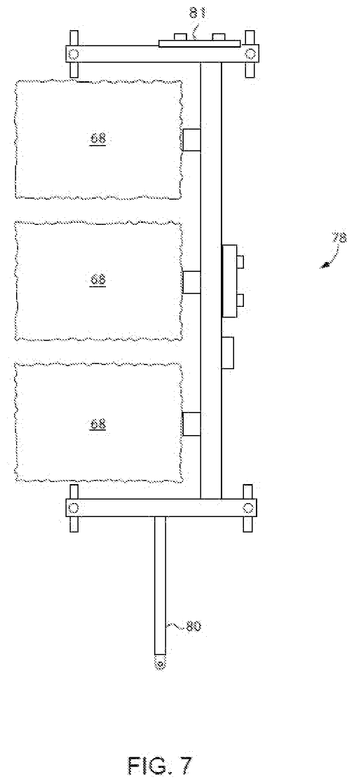

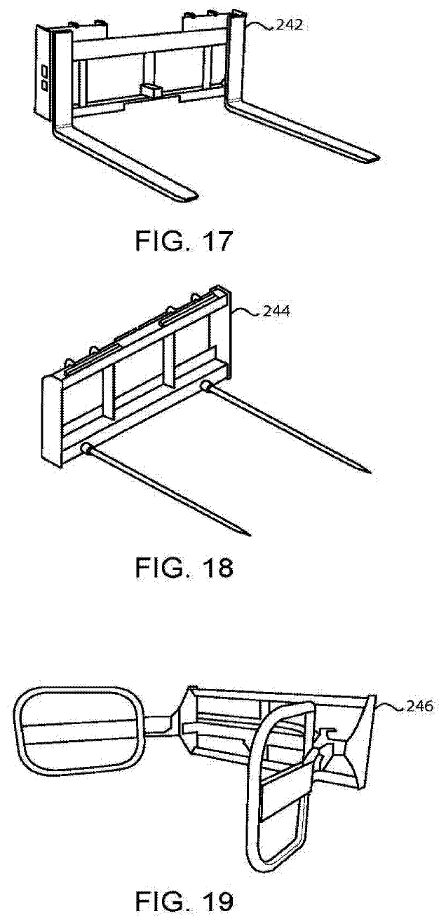

FIGS. 2-4 show another example embodiment of the present invention, namely bale handing device 56 being used in conjunction with skid steer style loader 58. Bale handing device 56 in this example includes three lift mechanisms 60 each having pivotable bracket 64 and corresponding hydraulic rams 62 shown in a lifted position with each lift mechanism 64 engaged with one round bale 68. Wheel bracket 70, in this particular example, uses a pin locking mechanism. This particular example also includes first or primary frame member 74 as well as second or secondary frame member 76. Hydraulic controller 66 in this example is mounted to primary frame member 74. This particular example further includes tow bar or hitch 72 which is shown in an upward stowed position. Tow hitch 72 may also be moved to a lowered or use position which allows bale handling device 56 to be hitched to and towed behind a vehicle for transport. An example of bale handling device 78 having a tow hitch 80 in the lowered position is shown in FIG. 7. Optionally, such a tow hitch or bar may be removable from the bale handling device when not in use. The bale handling device 78 optionally further includes a traditional single bale handling attachment 81 removably mounted to a side frame member. Bale handling attachment 81 includes an attachment plate having one or more attachment mechanisms suitable for attaching the bale handling attachment 81 to a loader machine. The bale handling attachment 81 may be a spear-style device, lifting, pallet forks, bale clamps, and/or tubular lift fingers, similar to those shown in FIGS. 17-22. The inclusion of a single bale handling attachment allows for greater flexibility when using the bale handling device disclosed herein. For example, such an attachment may be useful if a single bale as rolled into a position that makes gathering the bale difficult using one of the disclosed bale handling devices. Such an attachment may also be useful when loading bales onto a trailer or if moving bales into a shed or barn. Single bale handling attachments 81 may optionally be removably mounted to any of the bale handling devices disclosed herein.

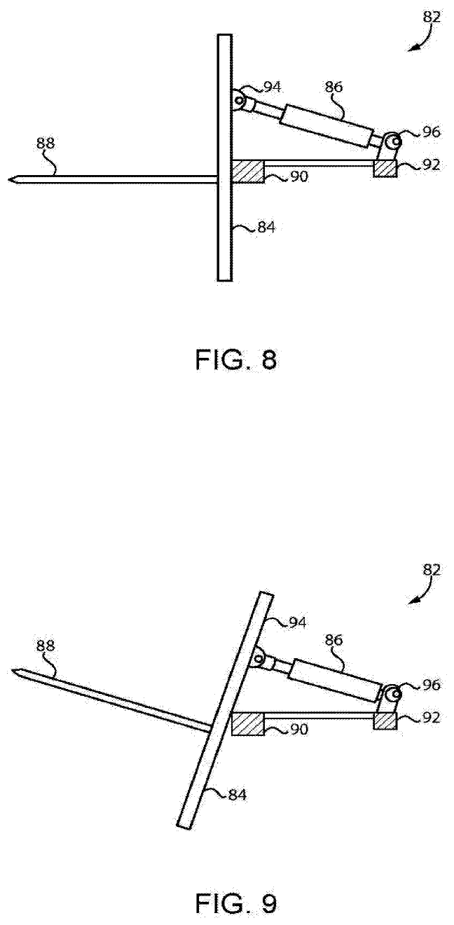

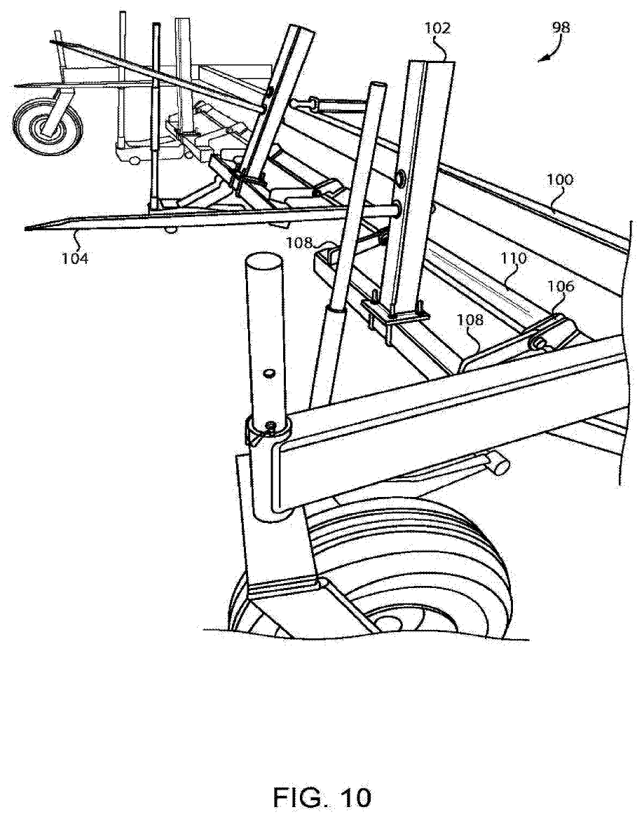

FIGS. 8-9 show a further exemplary embodiment of the present invention, namely lift mechanism 82 included in the bale handling devices described herein. In this particular example, lift mechanism 82 includes pivotable bracket 84 having bale spear 88 and hydraulic ram 86. Pivotable bracket 84 is pivotably mounted to a frame member 90 of any of the afore described bale handling devices. First end 94 of hydraulic ram 86 is mounted to pivotable bracket 84 and second end 96 of hydraulic ram 86 is mounted to a frame member 92 of the bale handling device. Hydraulic ram 86 is configured such that when in a first position (FIG. 8) pivotable bracket 84 is in the lowered position (substantially horizontal) and when in a second position (FIG. 9) pivotable bracket 84 is in the raised position (inclined with respect to a horizontal plane).

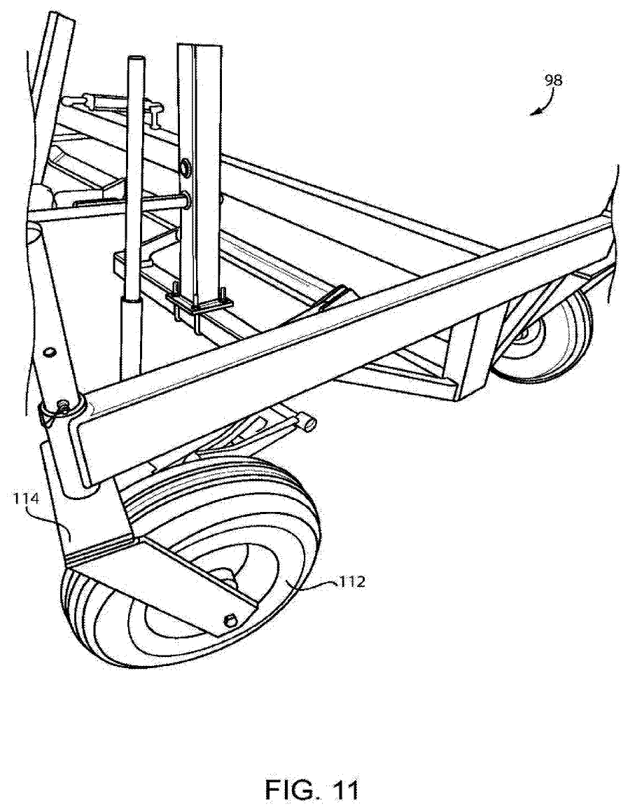

FIGS. 10-11 show another exemplary embodiment of the present invention, namely bale handling device 98 having first frame member 100 and second frame member 110. Pivotable bracket 102 having bale spear 104 also includes two mounting members 108 attached to hinge members 106 mounted on second frame member 110. This particular example includes wheel brackets 114 of the castor style which allows wheels 112 to automatically pivot and turn towards whichever direction bale handling device 98 may be pushed or pulled. Optionally, such wheel brackets may be locked into a particular position as desired, for example, when towing the bale handling device 98 on a road.

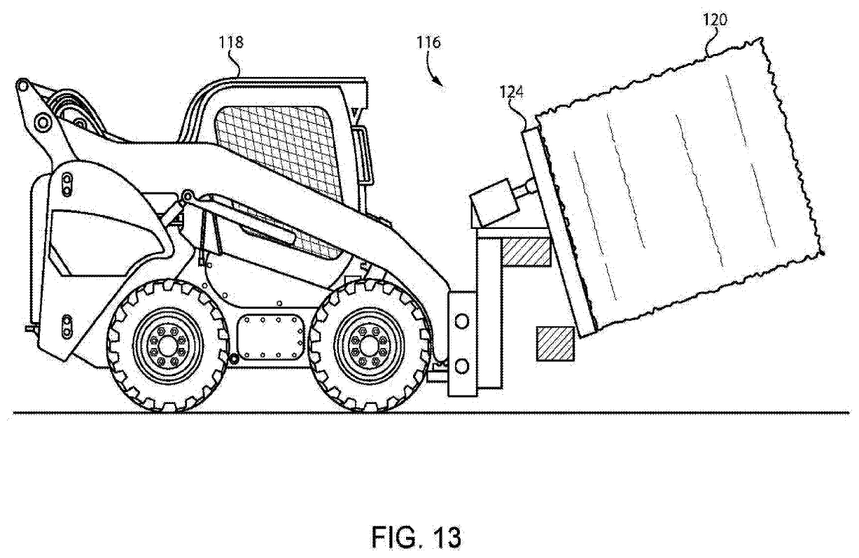

FIGS. 12-13 show another exemplary embodiment of the present invention, namely bale handling device 116 engaged with skid steer style loader 118 carrying three bales 120 on lift mechanisms 124 which are in the lifted position. Wheels 122 in this particular example are castor style wheels which allows loader 118 to push a fully loaded bale handling device 116 while wheels 122 support the weight of the bales thereby putting less strain on the lift arms and hydraulic system of loader 118. Such a configuration allows an operator to quickly and efficiently pick up bales which are scattered around a field and move them to a desired location. Optionally, the bale handling devices disclosed herein may also be configured so as to allow an operator to lift the handling device and bales using the loader's lift mechanism so as to place the bale simultaneously on a trailer or truck for transport. One or more of the wheel brackets may have to be moved (either manually or hydraulically) so as to prevent them from interfering with such a loading maneuver. In other examples, the wheel brackets may be positioned on the bale handling device so as to allow bales to be loaded onto a trailer directly from the handling device without the wheels interfering. For example, castors 122B may be eliminated such that only castors 122A are used to support the bale handling device 116 thereby allowing the bales to be lifted and maneuvered onto a flatbed wagon without interference from the forward casters 122B. In this particular example the hydraulic control module 119 is mounted to the bale handling device 116 at a distance from where the loader 118 is coupled to the bale handling device 116.

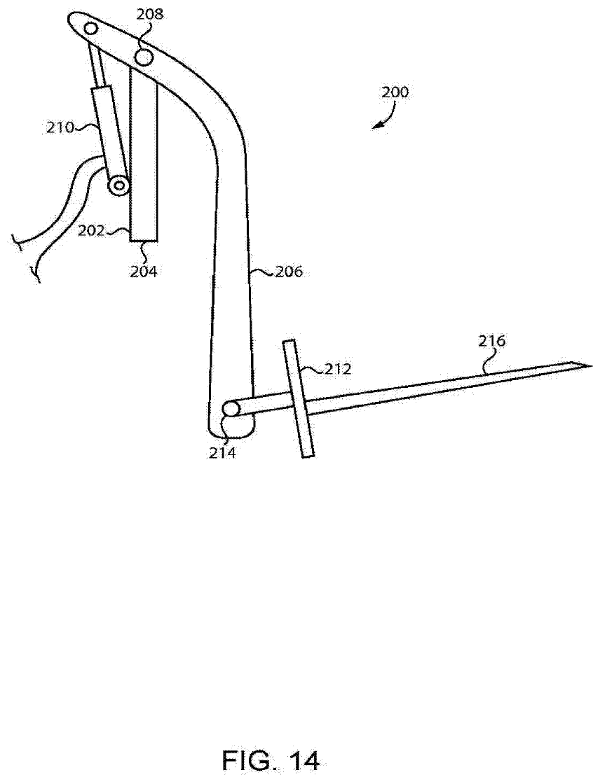

FIG. 14 shows an improved bale handling device attachment 200 according to another embodiment of the present invention. Bale handling device attachment 200 includes support beam 202 having mounting point 204 for mounting device attachment 200 to an existing bale handling device and lift arm 206 pivotably attached at 208 to support beam 202. Lift arm 206 may be raised and lowered relative to support beam 202 with hydraulic ram 210 operably attached to both support beam 202 and lift arm 206. Bale securing assembly 212 is mounted to lift arm 206 at attachment point 214.

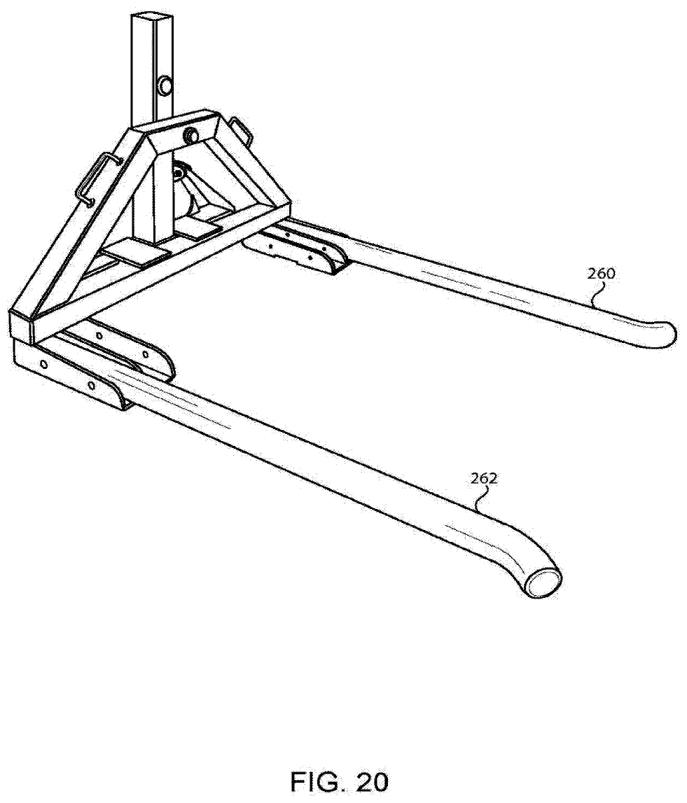

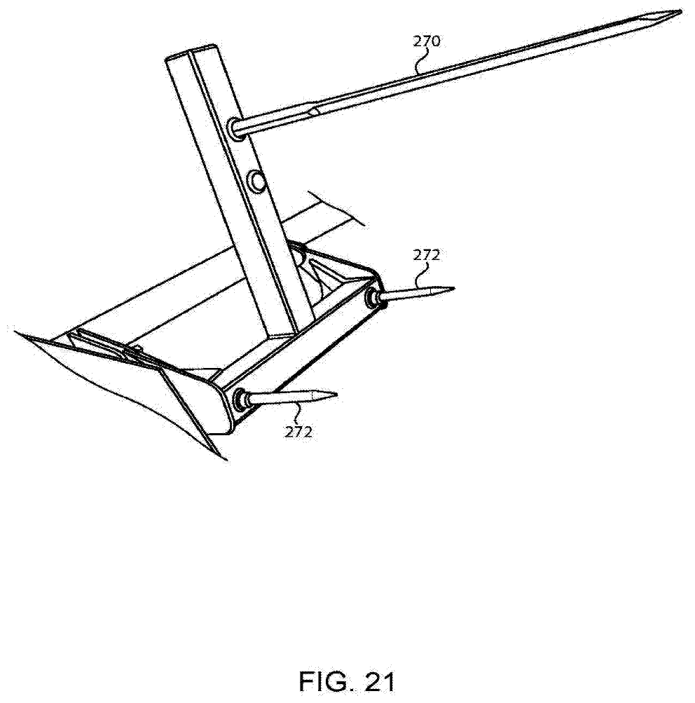

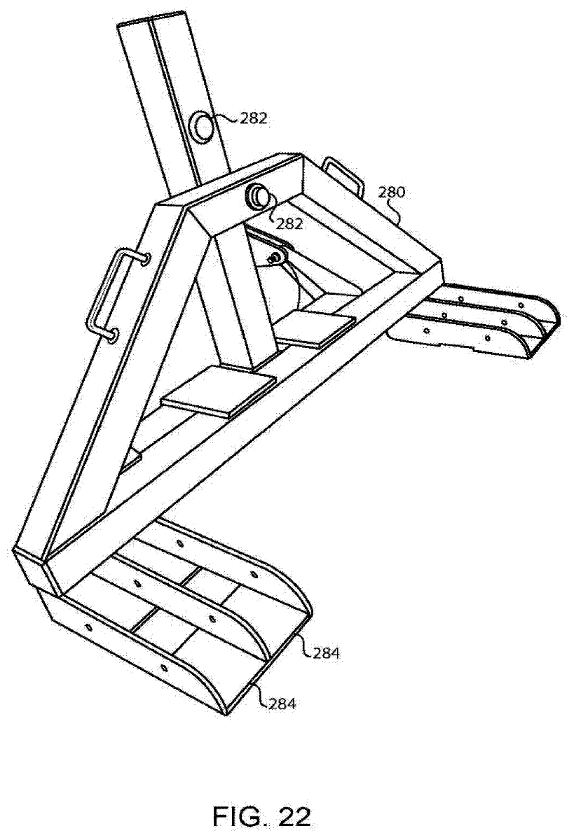

In this particular example, bale securing assembly 212 includes bale spear 216, but in other examples different bale securing mechanisms for capturing, transporting, and depositing bales from a field to suitable long range transport, for example without limitation a tractor trailer, truck bed, or other suitable agricultural or industrial transportation arrangement. Such alternative bale securing mechanisms include, but are not limited to, pallet-style forks 242 (as shown in FIG. 17), spear-style forks 244 (as shown in FIG. 18), and clamps 246 (as shown in FIG. 19) may also be used. Optionally, the use of pallet style forks as shown in FIG. 17 could allow a bale handling device equipped with such forks to lift and move items other than bales that were stacked on traditional pallets. Additionally, generally tubular lifting fingers 260 as seen in FIG. 20 may also be used. Such lifting fingers 260 may include rounded over or blunted end portions 262 which allow for the pick up and handling of bales wrapped in plastic material so as to reduce or eliminate the risk of ripping or tearing the wrapping material. In another example of alternative lifting means, a primary bale spear 270 may be used in conjunction with one or more secondary bale spears 272 as seen in FIG. 21. Such secondary spears 272 prevent a bale from rotating about the primary spear 270 when the bale is picked up. In yet another example, a modifiable mounting bracket 280 as shown in FIG. 22 may be used. Such a bracket 280 may include one or more mounting points 282 for mounting bale spears such as those shown in FIG. 20 as well as one or more mounting points 284 for mounting lifting fingers such as those shown in FIG. 21 and/or pallet lift forks such as shown in FIG. 17. This style of generic or adaptable mounting bracket 280 allows for different lifting techniques to be used as desired. For example, a spear style fork may be used to collect straw bales then removed and lift fingers installed to pick up silage bales wrapped in plastic. The various styles of lifting brackets and/or devices described herein may be adapted and mounted to any of the bale handling devices described herein. Optionally, different styles of lifting brackets and/or devices may be used simultaneously on a single bale handling device if so desired.

The bale handling device attachment 200 is designed and configured so that it may be mounted as an optional attachment to bale handing devices discussed previously. For example, the device attachment 200 may be used in conjunction with a bale handling device such as the one shown in FIGS. 10-11. In this particular example the bale spear 104 may be removed from the pivotable bracket 102. The support beam 202 is then mounted and secured to the pivotable bracket using the mounting point 204. Hoses from the hydraulic cylinder 210 may then be attached to the hydraulic system of the bale handling device 98 to allow for raising and lowering of the lift arm 206. Use of the bale handling device attachment 200 in conjunction with the bale handling device 98 allows for increased lift and range of motion when moving and lifting bales. Optionally, such a configuration would also allow for the lifting of a single bale while the other bales engaged with the bale handling device remained in a lowered (but still carried) position. For example, such a configuration would allow for the lifting and depositing of a single bale into a feeder while the bale transport still held other bales.

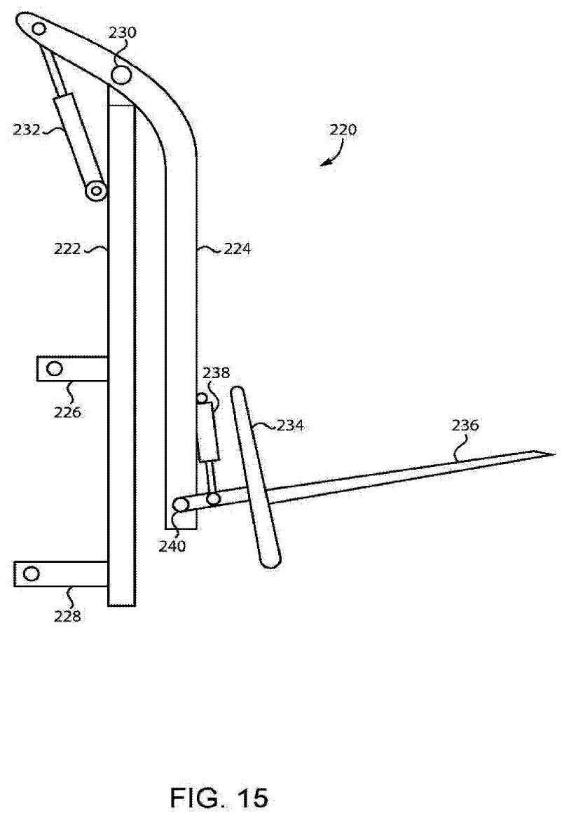

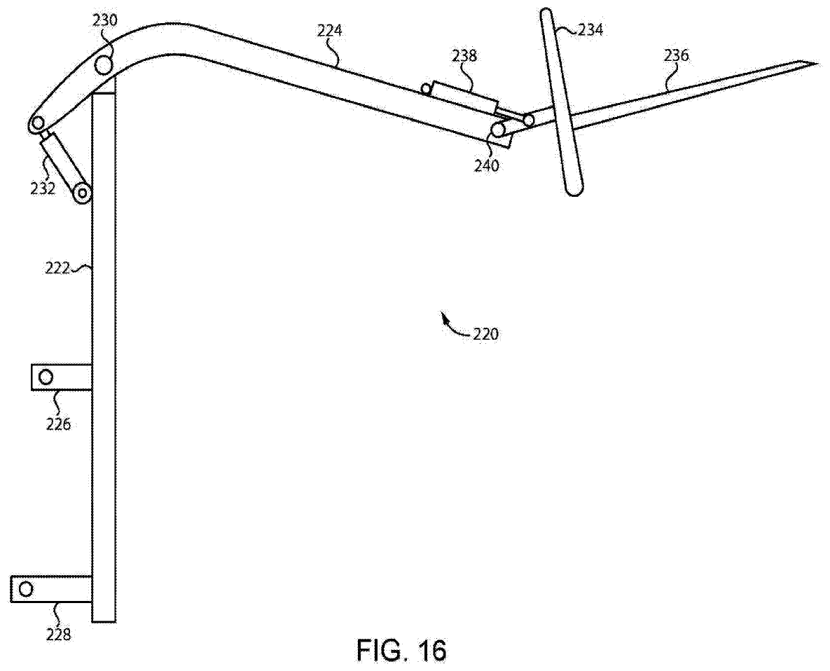

In another embodiment, pivotable bracket 102 from bale handling device 98 shown in FIGS. 10-11 may be omitted entirely and replaced with bale handling lift assembly 220 shown in FIGS. 15-16. Bale handling assembly 220 includes main support member 222 which is mountable to the frame of chassis of one of the previously discussed bale handling devices using one or more mounting points 226, 228. Mounting points 226, 228 may be pivotably or fixedly mounted to the chassis or frame of the bale handling device. Bale handling assembly 220 further includes lift arm 224 which is pivotably mounted 230 to main support member 222. Lift arm 224 may be raised (FIG. 16) or lowered (FIG. 15) using hydraulic cylinder 232 which is operationally mounted to both main support member 222 and lift arm 224 (hoses for the cylinder have been omitted for clarity, but it is understood that such hoses may be operationally connected to the hydraulic system of the bale handling device). Bale securing assembly 234 is pivotably mounted 240 to lift arm 224 and may be raised or lowered using hydraulic cylinder 238 which is operationally connected to lift arm 224 and bale securing assembly 234 (hoses for the cylinder have been omitted for clarity, but it is understood that such hoses may be operationally connected to the hydraulic system of the bale handling device). Bale securing assembly 234 is shown as having bale spear 236, but other bale securing methods such as pallet-style forks 242, spear-style forks 244, clamps 246, lifting fingers 260, multi spear arrangements 270, 272 as shown in FIGS. 17-21 may also be used.

The bale handling lift assemblies shown in FIGS. 14 and 15-16 allow for bale handling devices equipped with such lift assemblies to raise bales during handling so as to place them directly onto tucks or trailers or to stack bales onto other bales for storage. As with previous embodiments, the bale lift assemblies may be individually actuated so as to raise or lower a single assembly at a time is so desired. Such bale lift assemblies 200, 220 are movable between a lowered/carry position (FIGS. 14 and 15) and a raised/lifted position (FIG. 16). Bales may be picked up and moved about a field with the assemblies 200, 220 in the lowered/carry position then placed on a trailer, for example, by moving the assemblies 200, 220 into the raised position, maneuvering the bale handling device relative to the trailer, then lowering the bales onto the trailer.

In the various embodiments, the bale spears may optionally include a moisture sensor. Such a sensor may be electronically coupled, via a wired connection or a wireless connection, to a measuring device so that each bale may be rated for its moisture content. Optionally, such measures of moisture may be associated with the bales using farm accounting software, bale tagging, or other methods tracking the measured moisture values with the bales. Such sensors may be mounted to one or more bale spears or other suitable locations. Controllers or other associated devices may be mounted to the bale handling device as desired.

In the various embodiments, the bale spears and/or the bale lifting forks may optionally include an associated weight sensor. Such a sensor may be electronically coupled, via a wired connection or a wireless connection, to a measuring device so that each bale may be rated for its weight. Optionally, such measured weight may be associated with the bales using farm accounting software, bale tagging, or other methods tracking the measured weight values with the bales. Such sensors may be mounted to one or more bale spears or other suitable locations. Controllers or other associated devices may be mounted to the bale handling device as desired.

The disclosed bale handling devices eliminate the need to drive to the end of a field to a deposit point after collecting a single bale making the collection of bales more time and fuel efficient as well as less wearing on the loader machine. The use of stabilizing wheels on the bale handling devices improves stability of the devices thereby allowing for higher travel speeds while collecting and moving bales in uneven fields as well as decreasing the wear and tear on the loader machine. The disclosed bale handling devices also allow for faster loading of bales onto trailers, faster deposit of bales at a storage point in a field or in a barn, and faster processing by bale wrapping equipment.

In addition to the presently disclosed invention, the inventor has further invented an enhanced method and apparatus for wrapping bales handled by the disclosed bale handling devices. Most bale wrapping devices allow for the insertion of a single bale to be wrapped into the device. The bale is then wrapped and discharged before a new bale may be inserted. As the bale handling devices disclosed herein allow for the easy transport and deposit of multiple bales simultaneously, a bale wrapping device may be modified so as to accept two or more bales at once into a queue (such as a conveyor belt system, rollers, or the like). In one example, a conveyor belt system (not shown in the present disclosure) which can accommodate up to three bales is configured to feed bales one at a time into a bale wrapping device. The device then wraps a bale, ejects the wrapped bale, then the conveyor system feeds the next bale into the wrapping device. Such a conveyor system would allow a user to collect and shuttle bales around a field while the bale wrapping device was automatically being fed bales to wrap by the conveyor. Optionally, such a conveyor system may include a turntable portion which rotates bales prior to feeding them into the wrapping device if the wrapping device requires them to be in a particular orientation (e.g., if bales must be inserted flat face first into the wrapper). In other examples, a bale wrapping device may be designed having such a conveyor system integrated into the wrapping device itself.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed:

1. A bale handling device configured for being operationally mounted on a vehicle loader, the device comprising:
a vehicle loader attachment portion;
a frame support portion operably coupled to the vehicle loader attachment portion and having a first main frame member, a first side frame member attached at one end of the first main frame member, a second side frame member attached to the first main frame member distal from the first side frame member; and
at least one bale securing assembly pivotally mounted on the frame support between the first side frame member and the second side frame member and movable between a first position and a second position.

2. The bale handling device of claim 1, further comprising a hydraulic controller mounted to the bale handling device and operably connectable to a hydraulic system of a vehicle engaged with the vehicle attachment portion, the hydraulic controller configured to move the at least one bale securing assembly between the first position and the second position.

3. The bale handling device of claim 2, wherein the first position is a lowered position, the second position is a carry position, and the at least one bale securing assembly is further movable to a third position that is a raised position.

4. The bale handling device of claim 2, further comprising a second and third bale securing assembly pivotally mounted on the frame support between the first side frame member and the second side frame member and movable between a first position and a second position, wherein each bale securing assembly is individually movable by the hydraulic controller between the first position and the second position.

5. The bale handling assembly of claim 1, further comprising at least one wheel assembly operationally mounted to the first side frame member and at least one wheel assembly operationally mounted to the second side frame member.

6. The bale handling assembly of claim 1, wherein the vehicle loader attachment portion is disposed between the first side frame member and the second side frame member.

7. The bale handling device of claim 1, further comprising a second main frame member disposed between the first side frame member and the second side frame member, wherein the at least one bale securing assembly is pivotally mounted to the second main frame member.

8. The bale handling device of claim 1, further comprising a moisture sensor attached to the at least one bale securing assembly.

9. The bale handling device of claim 1, wherein the at least one bale securing assembly includes one of a bale spear, pallet forks, bale clamps, and tubular lift fingers.

10. A method of collecting and moving fodder bales, comprising:
providing a bale handling device having:
a vehicle loader attachment portion;
a frame support portion operably coupled to the vehicle loader attachment portion and having a first main frame member, a first side frame member attached at one end of the first main frame member, a second side frame member attached to the first main frame member distal from the first side frame member;
at least two bale securing assembly pivotally mounted on the frame support between the first side frame member and the second side frame member and movable between a first position and a second position;
a hydraulic controller mounted to the bale handling device and configured to move the at least two bale securing assembly between the first position and the second position;
attaching the loader of a vehicle having a hydraulic system to the vehicle loader attachment portion of the bale handling device;
operationally connecting a hydraulic controller of the bale handling device to the vehicle hydraulic system;
positioning the vehicle so as to engage a first fodder bale with one of the at least two bale securing assembly in the first position;
operating the vehicle hydraulic system to selectively move the bale securing assembly engaged with the first fodder bale to the second position thereby lifting the first fodder bale;
positioning the vehicle so as to engage a second fodder bale with the other of the at least two bale securing assembly in the first position;
operating the vehicle hydraulic system to selectively move the bale securing assembly engaged with the second fodder bale to the second position thereby lifting the second fodder bale;
driving the vehicle and bale handling device to a desired location;
operating the vehicle hydraulic system to selectively move the bale securing assembly engaged with the first fodder bale to the first position;
operating the vehicle hydraulic system to selectively move the bale securing assembly engaged with the second fodder bale to the first position; and
positioning the vehicle so as to disengage the first and second fodder bales from the at least two bale securing assemblies.

11. The method of collecting and moving fodder bales of claim 10,
wherein the at least two bale securing assemblies are further movable to a raised third position;
after driving the vehicle and bale handling device to a desired location:
operating the vehicle hydraulic system to selectively move the bale securing assembly engaged with the first fodder bale to the raised third position;
operating the vehicle hydraulic system to selectively move the bale securing assembly engaged with the first fodder bale to the first position;
operating the vehicle hydraulic system to selectively move the bale securing assembly engaged with the second fodder bale to the raised third position;
operating the vehicle hydraulic system to selectively move the bale securing assembly engaged with the second fodder bale to the first position;
positioning the vehicle so as to disengage the first and second fodder bales from the at least two bale securing assemblies.

12. A bale handling device configured for being operationally mounted on a vehicle's lift arms, the device comprising:
a vehicle lift arm attachment portion;
a frame support portion operably coupled to the vehicle lift arm attachment portion and having a first main frame member, a first side frame member attached at one end of the first main frame member, a second side frame member attached to the first main frame member distal from the first side frame member;
three bale securing assemblies pivotally mounted on the frame support between the first side frame member and the second side frame member and individually movable between a first position and a second position; and
a hydraulic controller mounted to the bale handling device and configured to selectively move the bale securing assemblies between the first position and the second position.

13. The bale handling device of claim 12, wherein the hydraulic controller is configured to be operationally connected to and operated by a vehicle's hydraulic system.

14. The bale handling device of claim 12, wherein the first position is a lowered position, the second position is a carry position, and the bale securing assemblies are further movable to a third position that is a raised position.

15. The bale handling assembly of claim 12, further comprising at least one wheel assembly operationally mounted to the first side frame member and at least one wheel assembly operationally mounted to the second side frame member.

16. The bale handling assembly of claim 15, further comprising at least two wheel assembly operationally mounted to the first side frame member, at least two wheel assembly operationally mounted to the second side frame member, and a tow hitch mounted to the first side frame member to allow the bale handling assembly to be towed by a vehicle.

17. The bale handling assembly of claim 12, wherein the vehicle lift arm attachment portion is disposed between the first side frame member and the second side frame member.

18. The bale handling device of claim 12, further comprising a second main frame member disposed between the first side frame member and the second side frame member, wherein the bale securing assemblies are pivotally mounted to the second main frame member.

19. The bale handling device of claim 12, further comprising a moisture sensor attached to the at least one of the bale securing assemblies.

20. The bale handling device of claim 12, wherein the bale securing assemblies includes one of a bale spear, pallet forks, bale clamps, and tubular lift fingers.
